(19) United States
(12) Patent Application Publication
(10) Pub. No.: US 2011/0036785 A1
(43) Pub. Date: Feb. 17, 2011

(54) WASTE SOLID CLEANING APPARATUS

(75) Inventor: Andrew Martin, Aberdeen (GB)

Correspondence Address: INTELLECTUAL PROPERTY / TECHNOLOGY LAW, PO BOX 14329, RESEARCH TRIANGLE PARK, NC, 27709, US

(73) Assignee: DLD ASSOCIATES LIMITED, Aberdeenshire (UK)

(21) Appl. No.: 12/747,482

(22) PCT Filed: Dec. 15, 2008
(86) PCT No.: PCT/GB08/04125

§ 371 Date: Oct. 19, 2010

(30) Foreign Application Priority Data
Dec. 13, 2007 (GB) 0724268.8
Dec. 13, 2007 (GB) 0724269.6
Dec. 13, 2007 (GB) 0724270.4

(51) Int. Cl. E21B 21/06; B01D 21/00; B01D 21/30; G01N 21/35

(52) U.S. Cl. 210/770; 210/252; 210/173; 210/201; 210/143; 210/239; 356/51

(57) ABSTRACT

There is herein described the removal of fluid from fluid-contaminated waste solids and a method and apparatus for analysing and detecting the amount of oil in a fluid-contaminated waste material. In particular, there is described the removal of oil from drill cuttings at an offshore rig, onshore treatment facility and other oily wastes such as refinery wastes and an improved method and apparatus for analysing and detecting the amount of oil in solid material (e.g. drill cuttings) from an offshore rig, onshore treatment facility and other oily wastes such as from refinery wastes.

### FIELD OF THE INVENTION

This invention relates to the removal of fluid from fluid-contaminated waste solids and a method and apparatus for analysing and detecting the amount of oil in a fluid-contaminated waste material. In particular, the present invention relates to the removal of oil from drill cuttings at an offshore rig, onshore treatment facility and other oily wastes such as refinery wastes and an improved method and apparatus for analysing and detecting the amount of oil in solid material (e.g. drill cuttings) from an offshore rig, onshore treatment facility and other oily wastes such as from refinery wastes.

### BACKGROUND OF THE INVENTION

Drilling “fluids” are oil or water-based formulations which are used to remove waste and debris in a well bore, stabilise the well bore and act as a lubricant during the drilling of wells. Oil-based muds tend to have a superior performance and are particularly used in difficult drilling conditions, such as during horizontal drilling.

Drilling mud is pumped down the internal bore of the drill string to a drill bit and this provides lubrication to the drill string and the drilling bit. Mud returning to the surface via the annular space between the drill string and the well bore carries with it cuttings material. These drill cuttings will typically be saturated with drilling fluid base oil.

The returning mud with entrained drill cuttings is subsequently separated into drilling mud and cuttings, such as by the use of the rig shaker system or other separating equipment. The separated mud may then be reused, while the oil-contaminated cuttings are removed for subsequent treatment and disposal.

However, removal and disposal of oil-contaminated drill cuttings is a major problem in the oil industry since the drill cuttings may contain up to 20% oil by weight. For environmental reasons, current legislation in many countries, such as EU OSPAR regulations, only permits the dumping of cutting material which has far lower oil content.

During offshore operations, it is current practice to collect and store the oil-contaminated drill cuttings on an offshore drilling unit and thereafter transport the drill cuttings by boat to an onshore location for treatment and disposal. There are two main storage and transport methods for removing the cuttings: skips; and bulk storage tanks. Skips are problematic as large numbers are required for each operation with many crane lifting movements which are hazardous. Additionally, the crane cannot operate in high winds which may lead to the drilling operation being suspended which can incur significant costs. Bulk storage tanks although reducing the number of crane movements still require the use of boats to transport the cuttings.

Known offshore treatment systems such as thermal desorption have also been used offshore. Known offshore treatment systems are also typically bulky and lack mobility. Previous systems are also relatively inefficient, have high energy consumption, generate significant heat and are expensive to operate.

It is desirable to provide an apparatus which reduces the storage space required. It is desirable to provide an apparatus which can remove oil from oil-contaminated wastes to an acceptable degree allowing the disposal of the wastes. In particular, it is desirable to remove oil from oil-contaminated drilling waste such as drill cuttings to a level below 1% so that the treated drill cuttings may be disposed of overboard from an offshore drilling platform or vessel.

It is necessary to separate the drilling mud and cuttings so that the drilling mud may be re-used and the cuttings disposed. Typically, shaker screens are used but other separating equipment is necessary to treat the mud-coated cuttings. A common method of doing this is using a cuttings dryer, such as a vertical cuttings dryer (VCD) which utilises less space. Cuttings from the cuttings dryer are then typically passed to a conical hopper including a base tube which collects the cuttings and gradually feeds the cuttings via the base tube to either storage devices or further treatment apparatus.

However, it has been found that conventional hoppers suffer from a number of disadvantages. For instance, the conical profile encourages the cuttings to concentrate at the entrance of the base tube. The lower cuttings are under pressure from cuttings directly above them and, again due to the conical profile, from cuttings above and located laterally.

It has been found that the solid cuttings which have an irregular shape and size can often form a bridge and prevent or inhibit other cuttings from falling into the base tube. In the worst case, the entrance to the base tube can become completely clogged.

Furthermore, the conical profile entails that only one base tube is provided at the lowest portion of the hopper.

It is desirable to provide an improved apparatus which mitigates the problems described above.

Although there are many methods available for analysing the amount of oil in a fluid-contaminated waste material, the methods currently in use provide inaccurate measurements. For example, the method currently used to date on offshore rigs revolves around a retort method. A retort is a device used for distillation or dry distillation of substances. It consists of a spherical vessel with a long downward-pointing neck. The liquid/solids to be distilled is placed in the vessel and heated. The neck acts as a condenser, allowing the evaporated vapours to condense and flow along the neck to a collection vessel placed underneath.

A significant difficulty with retort methods is that the technique is very inaccurate and the technique usually has an error of about ±2%. Such errors make the measurement of values of less than 1% by wt. oil wholly inaccurate. It should be noted that before oil-contaminated material can be deposited into the ocean, new legislation now requires that the material has less than 1% by wt. oil. There is significant human error in conducting retort experiments which arises from the initial measuring out of the oil-contaminated material to be tested and then once oil has been evaporated off to measure the level of a meniscus level. Reading the level of a meniscus is notoriously difficult and is also dependent if the meniscus is concave or convex. This leads to significant experimental errors occurring with retort methods at low values of oil contamination.

It is an object of at least one aspect of the present invention to obviate or mitigate at least one or more of the aforementioned problems.

It is a further object of the present invention to provide an improved method of analysing and detecting the amount of oil in a fluid-contaminated waste material.

### SUMMARY OF THE INVENTION

According to a first aspect of the present invention there is provided a modular waste solid cleaning apparatus comprising:

an agitation module adapted to agitate a fluid-contaminated waste solid;

a dryer adapted to separate and remove the fluid from the fluid-contaminated waste solid, the dryer being fluidly connected to the agitation module;

a process module adapted to remove fluid from the fluid-contaminated waste solid; and

a control module adapted to control at least one parameter of each of the agitation module and the process module.

The fluid-contaminated waste solid may be an oil-contaminated material, for example, a drilling waste such as drill cuttings. The drill cuttings may be saturated with oil and may comprise up to about 20% oil by weight. The term “oil” herein is taken to mean any hydrocarbon compound.

The dryer may be any suitable form of dryer such as a vertical cuttings dryer which may, for example, be located above the process module.

The treatment module may include means to further reduce the particle size. Typically, the particle size may be reduced to an average particle size of less than about 1000 microns, preferably less than about 100 microns, or most preferably less than about 10 microns. Conveniently, the particle size may be within the range of about 0 to 1000 microns, about 0 to 200 microns, or about 0 to 50 microns.

The reduction in particle size may be performed by any mechanical, physical, fluidic or ultrasonic means. Preferably, the particles may be reduced in size using shearing means. In particular embodiments, the shearing means may comprise at least one rotatable cutting blade.

By shearing it is meant that the particles are cut open thereby reducing the particle sizes and increasing the available surface area. Increasing the surface area facilitates the ability of a surfactant to remove fluid deposits entrapped in the fluid-contaminated material. To aid the shearing process, water may be added to the fluid-contaminated material to convert the material into a slurry.

Alternatively, grinding means may be used to reduce the sizes of the particles. Alternatively, an ultrasonic process using high frequency electromagnetic waves may be used to reduce the particle sizes. Alternatively, fluidic mixer such as an air driven diffuser mixer may be used which uses compressed air to suck the particles through a mixer. Alternatively, a cavitation high shear mixer may be used wherein a vortex is used to create greater turbulence to facilitate the reduction in particle sizes. Alternatively, a hydrocyclone apparatus or any other suitable centrifugation system may be used. The particle reducing means may comprise any combination of the above-described methods.

An electric current may be passed through the fluid-contaminated material. This does not affect the particle size but may assist to separate out the oil. It has been found that by using a burst cell electro-chemical system and by customising the wave shape, frequency and pulse, the fluid-contaminated material may be separated into, for example, three phases: an oil phase, a water phase and a solid phase. A centrifugation process may be used to separate the different phases.

Typically, the treatment module may be adapted to mix the fluid-contaminated solid with a water-based solution of a surfactant. The surfactant may be added to the fluid-contaminated material before or during the step of reducing the particle sizes.

The fluid-contaminated material and surfactant may be mixed with an excess amount of water. Preferably, the water includes a salt such as sodium chloride.

In particular embodiments, the modular waste solid cleaning apparatus may include means for separating the fluid from the solid waste material. Typically, the means may comprise a vertical cuttings dryer. Typically the vertical cuttings dryer may be provided as a separate pre-treatment module. There may also be post process centrifuges (e.g. one post-treatment vertical cuttings dryer and one decanter centrifuge).

The process module may also include liquid chemical separation means. The chemical separation means may comprise one or more flocculation tanks.

The control module may include testing means for testing one or both of the waste solid and the separated fluid. In particularly preferred embodiments, the control module may be a PLC controlled which may, for example, control a majority or all of the parameters in the process module. Typically, the testing means may be adapted for testing the obtained solid material to ensure that the amount of fluid has been reduced to an acceptable level such as below about 1% fluid by weight.

Solid material which includes an amount of fluid which has been reduced to an acceptable level may be discarded, such as overboard from an oil platform or vessel onto the seabed. The treated solid material according to the present invention is found to be non-hazardous. This has the significant advantage in that the treated solid material may be sent to landfill. This will have substantial cost savings not only in ease of disposal but this may also have some taxation advantages.

The modular waste solid cleaning apparatus may also include filtering means, such as one or more filters, for filtering the separated fluid. The filtering means may be provided as a separate filtration module.

According to a second aspect of the present invention there is provided a method of cleaning fluid-contaminated waste solid material, said method comprising:

providing an agitation module adapted to agitate a fluid-contaminated waste solid;

providing a dryer adapted to separate and remove the fluid from the fluid-contaminated waste solid, the dryer being fluidly connected to the agitation module;

providing a process module adapted to remove fluid from the fluid-contaminated waste solid; and

providing a control module adapted to control at least one parameter of each of the agitation module and the process module.

According to a third aspect of the present invention there is provided a waste solid cleaning apparatus comprising:

a separating apparatus adapted to separate fluid from a fluid-contaminated waste solid; and

a collecting container for collecting the waste solid following fluid separation, the collecting container having one or more side walls, a base and at least one base tube provided at the base for releasing the collected waste solid from the collecting container,

wherein the or each side wall is substantially vertical, and wherein the base is substantially horizontal.

The collecting container may be substantially cylindrical. Alternatively, the collecting container may be substantially cubical or cuboidal.

Typically, a plurality of base tubes may be provided at the base. The plurality of base tubes may be substantially evenly distributed at the base. In particular embodiments, three base tubes may be provided at the base.

Conveniently, the or each base tube comprises a cylindrical pipe having a substantially vertical orientation.

The collecting container may comprise a number of substantially vertical surfaces as well as the substantially horizontal surface of the base. This may inhibit the waste solid material from forming a bridge which can prevent other solid material from falling into the base tube.

Base clearing means may be provided for clearing the horizontal base of the collecting container. The base clearing means may comprise one or more of a sweeping device and/or vibrating means.

Typically, the separating apparatus may comprise a cuttings dryer. Moreover, the separating apparatus may comprise a vertical cuttings dryer.

The fluid-contaminated waste solid may be an oil-contaminated material, for example, a drilling waste such as drill cuttings.

The or each base tube may release the collected waste solid from the collecting container to further treatment apparatus. Alternatively, the or each base tube may release the collected waste solid from the collecting container to one or more storage devices.

According to a fourth aspect of the present invention there is provided a method of preventing blockage in a waste solid cleaning apparatus, said method comprising:

providing a separating apparatus adapted to separate fluid from a fluid-contaminated waste solid; and

providing a collecting container for collecting the waste solid following fluid separation, the collecting container having one or more side walls, a base and at least one base tube provided at the base for releasing the collected waste solid from the collecting container,

wherein the or each side wall is substantially vertical, and wherein the base is substantially horizontal.

According to a fifth aspect of the present invention there is provided a method of analysing an amount of oil in an oil-contaminated material said method comprising the following steps:

treating the oil-contaminated material with ultrasonic means;

agitating the oil-contaminated material; and

analysing the oil-contaminated material using IR spectroscopy.

The method may be used to analyse that is not dry and detect the amount of oil in an oil-contaminated waste material in an offshore environment. In particular, the present method may be used to analyse the amount of oil in moisture wet solid material (e.g. drill cuttings) from an offshore rig, and other oily wastes such as from refinery wastes. The method is particularly suitable for analysing drill cuttings.

The ultrasonic means may be any suitable type of ultrasonic bath which may operate in the ultrasonic range of, for example, about 15-400 kHz or about 100-200 kHz. The ultrasonic means has the effect of causing high frequency vibrations in the oil-contaminated material which aids the removal of the oil from the contaminated material. Otherwise, the oil remains attached to the solid material and it is not possible to get the material below 1 wt. % oil. The contaminated material may be treated with ultrasonic means for about 15 seconds, 30 seconds, 45 seconds, 1 minute, 1.5 minutes, 2 minutes, 2.5 minutes, 3 minutes, 3.5 minutes, 4 minutes, 4.5 minutes, 5 minutes, 6 minutes, 7 minutes, 8 minutes, 9 minutes and 10 minutes.

The oil-contaminated material is agitated to further promote the release of the oil from the contaminated material. Typically, a lab shaker may be used for this purpose which vibrates at a rate of about 10 to about 300 RPM. In contrast to previous investigations, the present inventors surprisingly found that it was necessary to agitate the material for much longer than expected to extract all of the oil. For example, the oil-contaminated material may be agitated for about 5 minutes, 10 minutes, 15 minutes, 20 minutes, 25 minutes, 30 minutes, 35 minutes, 40 minutes, 45 minutes, 50 minutes, 55 minutes and 60 minutes.

In particular embodiments, the present invention may use an FT-IR spectrometer which may use a filter based analyser to provide precise and accurate quantitative measurement of the amount of oil in the fluid-contaminated waste solid.

The oil-contaminated waste (e.g. drill cuttings) may initially be saturated with oil and may comprise up to about 20% oil by weight. The term “oil” herein is taken to mean any hydrocarbon compound.

The oil-contaminated waste may initially have been treated with an oil treatment solution such as a surfactant to form, for example, an emulsion, microemulsion (e.g. an oil-in-water microemulsion) or a molecular solution, an emulsion, microemulsion (e.g. an oil-in-water microemulsion) or a molecular solution. The oil-contaminated waste may also have been treated in a vertical cuttings dryer and may also have undergone a flocculating process.

### BRIEF DESCRIPTION OF THE FIGURES

Embodiments of the present invention will now be described, by way of example only, with reference to the accompanying drawings in which:

FIG. 1 is a perspective view of a modular waste solid cleaning apparatus according to an embodiment of the present invention;

FIG. 2 is a diagrammatic view of the modular waste solid cleaning apparatus of FIG. 1;

FIG. 3 is a side view of a treatment module of the modular waste solid cleaning apparatus of FIG. 1;

FIG. 4 is a plan view of a treatment module of the modular waste solid cleaning apparatus of FIG. 1;

FIG. 5 is a sectional side view of a waste solid cleaning apparatus according to an embodiment of the present invention; and

FIG. 6 is a sectional plan view of the waste solid cleaning apparatus of FIG. 5.

### DETAILED DESCRIPTION

The following description relates to the treating of oil-contaminated drill cuttings. However, other fluid-contaminated solid materials may also be treated in a similar way.

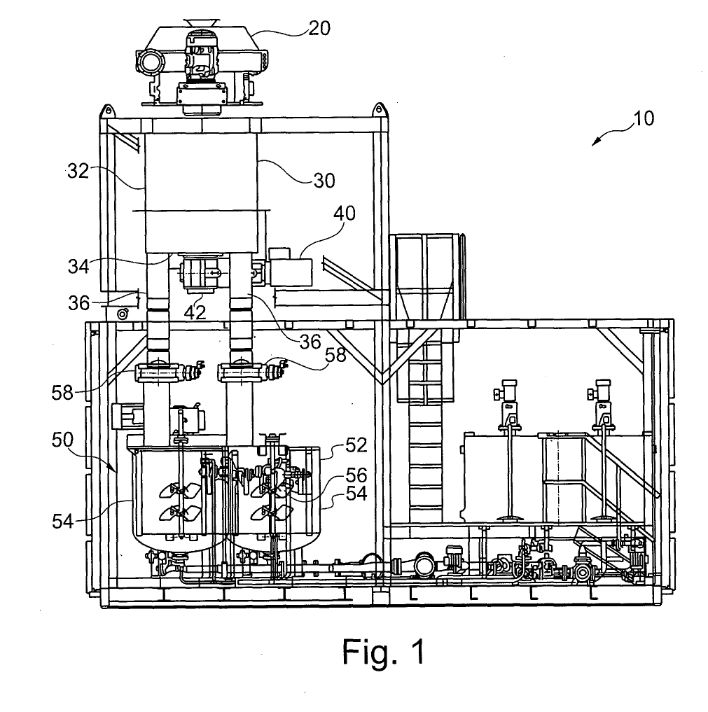

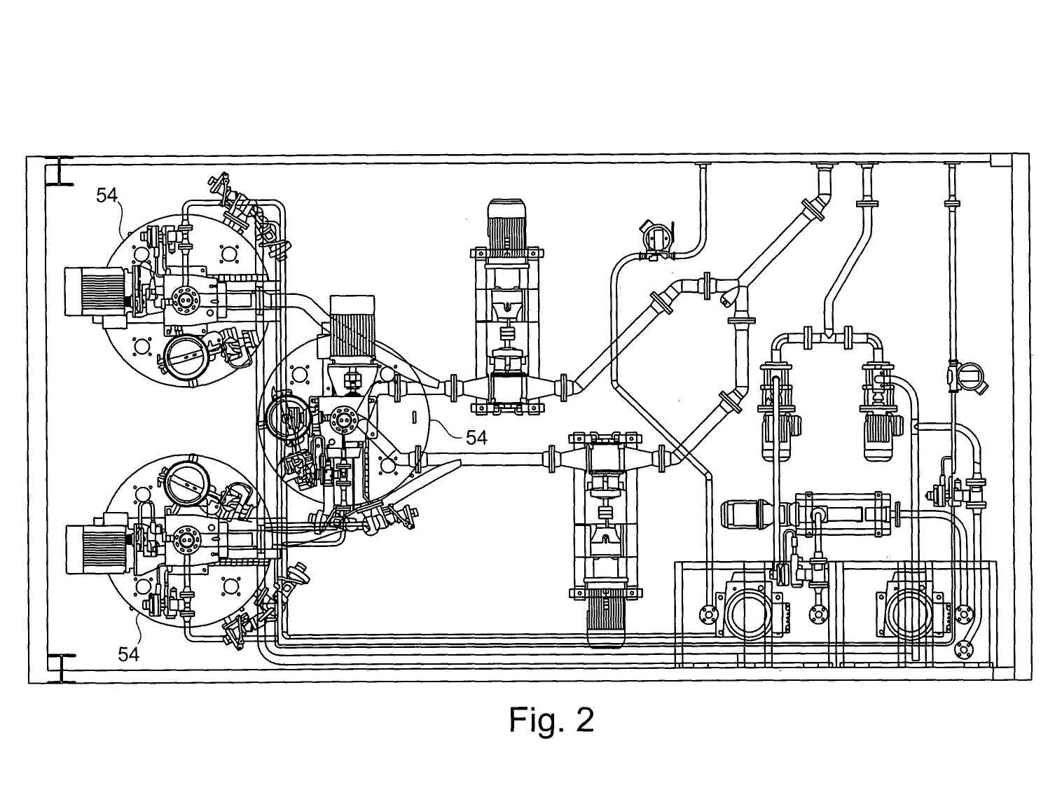

FIGS. 1 and 2 show a modular waste solid cleaning apparatus 10 which comprises an agitation module 20, a process module 30 and a control module 80.

As shown in FIGS. 1 and 2, drilling mud which has been circulated downhole becomes mixed with drill cuttings and flows out of the annulus as fluid and is then passed through a shaker system 54 which contains vibrating screens 52. These vibrating screens 52 are typically an existing component of conventional rigs. The liquid mud passes through the screens and flows back to the rig or platform active mud system for reuse.

If the recycled mud contains fine particles that would interfere with drilling performance, the mud may be treated using mud cleaners or centrifuges to remove very fine low gravity particles.

The solid cuttings coated with a film of mud remain on top of the shale shaker screens 54. These cuttings must be further treated to meet an acceptable standard of oil removal.

Drill cuttings are fed from the shale shakers 54 to the cuttings agitation module 20. Decanter centrifuge solids and solids from ongoing mud treatment may also be mixed with the cuttings to enable the cleaning of all rig solids waste.

The agitation module 20 is adapted to agitate and keep in suspension the oil-contaminated drill cuttings, using rotary blades.

The upstream vertical cuttings dryer 32 is fluidly connected to the agitation module 20 and sits on top of the process module 30, and a processing apparatus 34. The process module 30 is adapted, to further separate and remove fluid from the drill cuttings.

The agitated cuttings are fed into the upstream VCD 32 using a pump 36 and the upstream VCD 32 reduces the cuttings volume by 10 to 15%. The separated and recovered mud is passed from the upstream VCD underflow to mud pit 54 or storage.

The drill cuttings from the upstream VCD 32 are then passed to the mixing apparatus 34 to carry out an aqueous erosion process. This is a rapid process which typically runs for only 3 minutes. Oil-contaminated drill cuttings are mixed in a seawater and surfactant solution within the process apparatus 34.

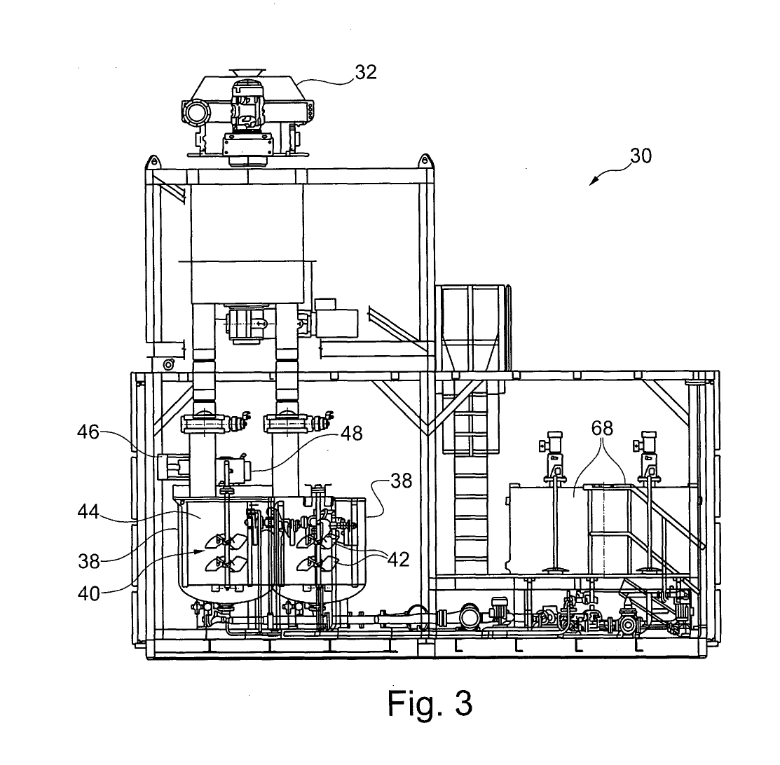

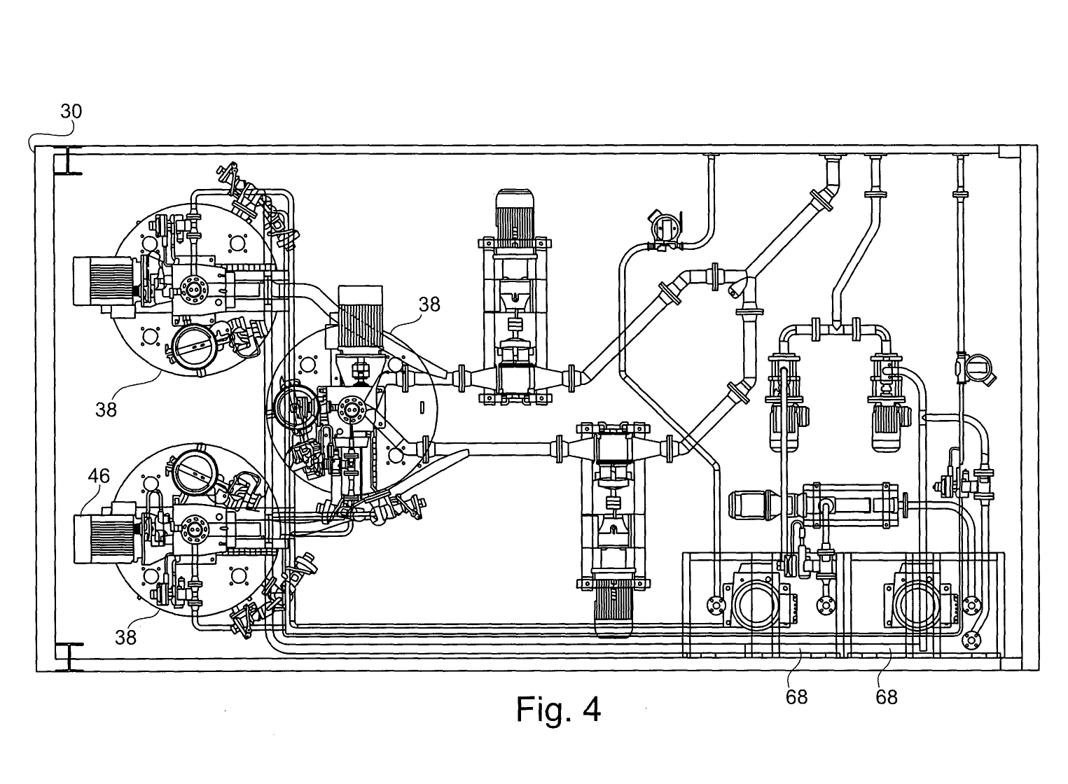

FIGS. 3 and 4 show the mixing apparatus 34 in more detail. The mixing apparatus 34 comprises three process vessels 38 and a mixer 40 associated with each process vessel 38. The mixer 40 comprises a number of rotatable blades 42 mounted on a drive shaft 44. The process vessel 38 also comprises a series of baffles. The baffles serve to increase turbulence during processing and improve the shearing process. The drive shaft 44 is connected to a motor 46 via gearing 48.

The mixer 40 shears the drill cuttings and reduces the particle sizes of the drill cuttings. This has the advantageous effect of increasing the surface area of the drill cuttings. The particles are reduced in size from about 0 to 1000 microns to about 0 to 100 microns. Increasing the surface area facilitates the access of the surfactant to oil deposits entrapped within the drill cuttings.

After mixing, the resulting mixture is passed to a post-treatment module 60 comprising a downstream VCD 61 which separates the drill cutting particles from the formed emulsion, microemulsion (e.g. an oil-in-water microemulsion) or molecular solution and water phase. The separated emulsion, microemulsion or molecular solution and water phases from the VCD 61 underflow are passed to a fluid holding tank 62. The separated solids are passed to a solids holding tank 64.

The substantially oil-free solids are then tested for oil contamination. Testing is performed using Fourier Transform Infrared Spectroscopy (FTIR) or Gas Chromatography (GC). If the solids are sufficiently clean, the solids may be discharged over the side of an oil platform or vessel onto the seabed.

If the solids are not clean enough, the solid material can be retreated through the cleaning cycle.

Liquid within the fluid holding tank 62 is flocculated at pump 92 and pumped to a decanter centrifuge 66 where mechanically assisted chemical separation takes place to remove any remaining fine solids particles. The centrifuge 66 and the downstream VCD 61 form the post-treatment module 60. Fine solids from the centrifuge 66 are passed to the solids holding tank 64 so that they can also be tested and safely disposed overboard. As shown in FIG. 1, there is a pipe 91 connecting the process module 30 and a pump 92. Flocculant is added in-situ at the pump 92 (i.e. the water is ‘spiked’) The advantage of adding the flocculant at the pump 92 is that this accelerates the removal of all fine particles and therefore separation by settlement is not required thus reducing the requirement for tank storage.

The sea water and oil mixture from the decanter centrifuge 66 is transferred to the decanter underflow tank 70 where it is coalesced before passing to filtration module 72. The water is then polished using standard offshore cartridge filtration means, such as 2 mm or 50 mm cartridges. Following testing at the control module, the remaining clean seawater may be disposed overboard or used to flush the cleaned solids overboard. The treated water typically has less than 100 ppm total hydrocarbon content in the liquid.

The whole process is operated, timed and controlled by the control module 80. Many different parameters of each of the modules are controlled, including safety devices and level sensors for halting the operation of the system if necessary and/or acting as a failsafe.

In use, cuttings enter the system via the conveyor 50. The material entering the system may have up to 20% oil by weight. Cuttings entering the system are transferred to the tanks 38 of the mixing apparatus 34 via the upstream VCD 32.

The first tank is initially filled until an appropriate level is reached. Sensors detect once the required level is reached. processing is then started. The system then fills the second tank. Once this tank is filled, the third tank is filled. Typically about a 90 s fill up time is involved. As the third tank is starting to fill, the second tank is starting to empty and the first tank is completely empty. A continuous batch process may therefore be set up.

The shearing blades 42 rotate at a speed of about 0 to 400 rpm and are used to shear the particles and so reduce the particle sizes in the surfactant which is mixed with seawater at this stage.

At the end of the shearing process, the resulting slurry is pumped to the downstream VCD 61 where liquid/solid separation takes place. The resulting liquid underflow is passed to a fluid holding tank 62. Resulting cleaned solids are transferred to the solids holding tank 64.

The resulting cleaned solids are then tested before discharge. The resulting solid material has less than 1% oil by weight such that the material may be discharged onto the seabed.

The resulting liquid is flocculated and pumped to a decanter centrifuge 66 where a further liquid/solid separation takes place.

The sea water and oil mixture from the decanter centrifuge 66 is transferred to the decanter underflow tank 70 and coalesced before passing to filtration module 72. The water polished using cartridge filtration means. Following testing at the control module, the remaining clean seawater may be disposed overboard.

The present invention has a number of advantages. These include the flexibility of a modular system and reduced space requirements. The core modules typically take up less than about 50 m². Other modules may be flexibly located around the rig.

Typically, the system can typically process about 12.4 cubic metres, or about 20 tonnes, of drilling waste per hour in real time. However, the system is also fully scalable to meet the requirements of any practical facility size.

The system has low energy consumption. In particular, the aqueous erosion process uses no heat and has low energy requirements, significantly reducing the risk of explosion and particulate contamination offshore.

The system enhances the existing solids control system which separates and recovers drilling mud and base oil. Also, existing power, air and water systems of the facility may be utilised.

The invention includes a natural aqueous erosion process which does not alter the physical properties or the nature of materials treated. The system operates in real time in that it keeps pace with the drilling operation, even in larger holes. No buffer storage, other than back-up buffer storage, is required. The system is mass balanced, such that any materials discharged during drilling are well within safe levels.

The following description relates to the treating of oil-contaminated drill cuttings. However, other fluid-contaminated solid materials may also be treated in a similar way.

Drilling mud which has been circulated downhole becomes mixed with drill cuttings. This drilling waste is first placed on a conveyor belt and passed through a series of vibrating screens typically called shale shakers. The liquid mud passes through the screens and is passed back to mud pits on the platform for reuse. The solid cuttings coated with a film of mud remain on top of the shale shakers and are then fed to a cuttings agitation device which reduces the particle size of the drill cuttings using rotary cutting blades. The cuttings are then passed to a separating apparatus, which comprises a vertical cuttings dryer (VCD) 20, for separating oil from the drill cuttings.

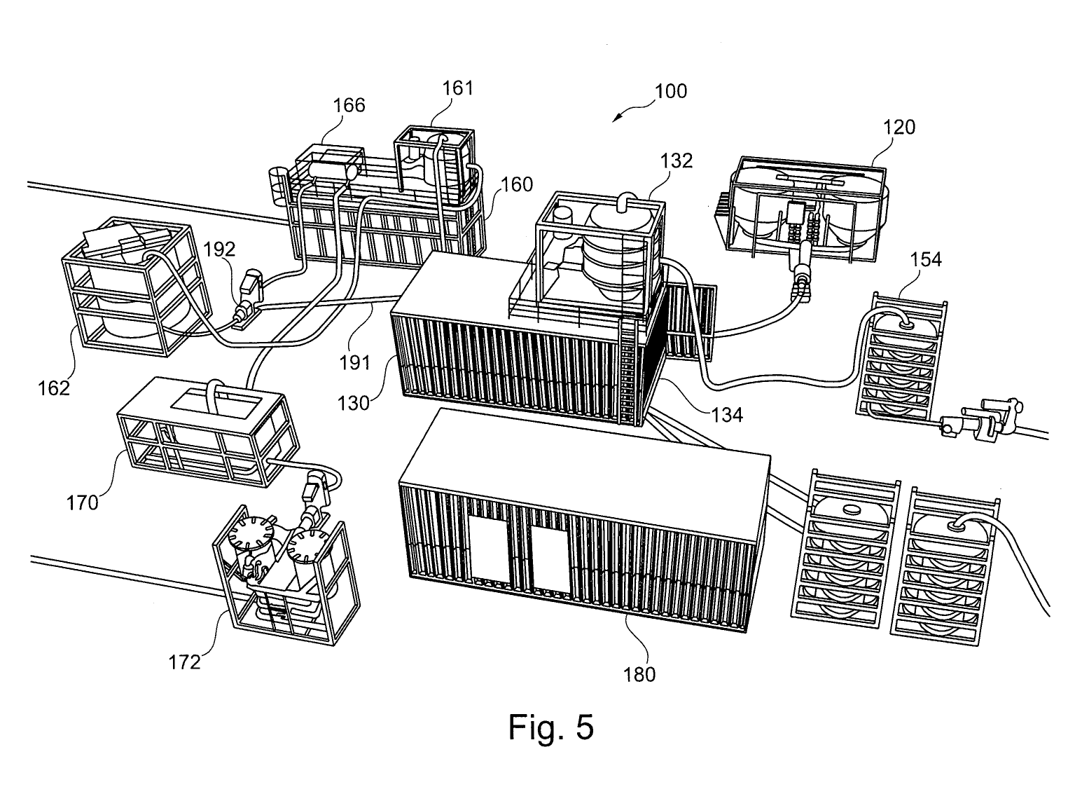

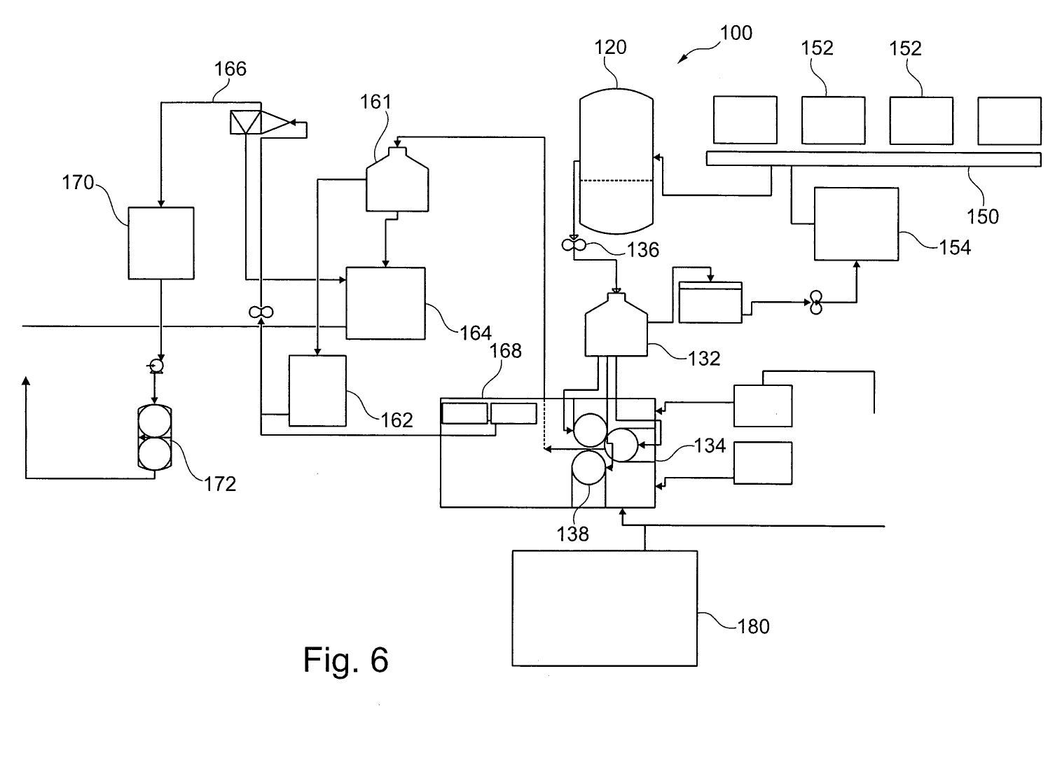

FIGS. 5 and 6 show a waste solid cleaning apparatus 100 which comprises the VCD 120 and a collecting container 130 for collecting the drill cuttings following oil separation.

The collecting container 130 is cylindrical and has a side wall 132, a base 134 and three base tubes 136 provided at the base 134 for releasing the collected drill cuttings from the collecting container 130. The side wall 132 is substantially vertical, and the base 134 is substantially horizontal.

Each base tube 136 comprises a cylindrical pipe having a substantially vertical orientation. As shown best in FIG. 6, the three base tubes 136 are evenly distributed at the base 134.

The collecting container 130 therefore has a number of substantially vertical surfaces and the horizontal surface of the base 134.

Base clearing means (not shown) is provided for clearing the base 134 of waste solid. This comprises two rotary sweeping wipers mounted on a drive shaft located centrally at the base 134. The drive shaft is actuated by a motor 140 via gearing 142.

Each base tube 136 releases the collected drill cuttings from the collecting container 130 to further treatment apparatus 150. Drill cuttings from the collecting container 130 are fed to a mixing apparatus 152 to carry out an aqueous erosion process. Oil-contaminated drill cuttings are mixed in a seawater and surfactant solution within the mixing apparatus 122.

The mixing apparatus 134 comprises three container tanks 154 and a cavitation mixer associated with each container tank 154. The cavitation mixer 140 comprises a number of rotatable blades 156 which shear the drill cuttings and reduces the particle sizes of the drill cuttings. This has the advantageous effect of increasing the surface area of the drill cuttings.

After mixing, the resulting mixture is passed to further treatment devices (not shown) to separate the drill cutting particles from the formed oil-in-water microemulsion and water phase.

If the solids are sufficiently clean, the solids may be discharged over the side of an oil platform or vessel onto the seabed. For the liquid, the oil is separated and the water processed using cartridge filtration means, before disposal overboard.

The present invention has a number of advantages. The profile of the collecting container 130 evenly distributes the pressure on the lower cuttings. The provision of more than one base tube 136, and the even distribution of the base tubes 136, minimises the possibility of the cuttings forming a bridge which prevents or inhibits other cuttings from falling into the base tube 136.

The present invention also relates to a method and apparatus for analysing and detecting the amount of oil in an oil-contaminated waste material such as drill cuttings.

The present invention uses an FT-IR spectrometer to analyse the oil-contaminated waste material and can also be used with Gas Chromatography such as a Varian Saturn 2000 GCMSMS ion trap GC System. The FT-IR spectrometer uses a filter based analyser to provide precise and accurate quantitative measurement of the amount of oil in the oil-contaminated waste material.

In particular embodiments of the present invention Perkin Elmer Spectrum RX1 FTIR System using the DBERR Triple Peaks Method or InfraCal Filtometers from Wilks Enterprise, Inc. are used. InfraCal Filtometers are filter based infrared analysers, providing the precision and accuracy necessary for repetitive quantitative mid-IR measurements in the laboratory, in the manufacturing plant or in the field. The triple peaks method is as defined by DBERR (DTI) and measures three different hydrocarbon wavelengths thus allowing the system. The Perkin Elmer system is linked to a lab computer to allow the resultant graph to be drawn along with a printout of the aliphatic and aromatic content to differentiate between aliphatic and aromatic hydrocarbons.

The basic Filtometer used in the present invention uses a fixed band pass filter/pyroelectric detector having one or two measurement wavelengths.

The mid-IR region of the infrared spectrum occurs at about 2 to 20 micrometers (5000-500 cm⁻¹) and especially the “fingerprint region” of 5 to 15 micrometers (2000-667 cm⁻¹) is very useful for the present invention. This is due to organic functional groups having characteristic and well-delineated absorption bands in this spectral region. Since molecules differ from each other by having different combinations of functional groups, their mid-IR spectra can be used to identify them and characterize their structure.

Mid-IR spectra of mixtures are additive. Thus absorption bands associated with individual components can be used to quantify them by the strength of their absorption. Calibration data in the mid-IR region is much more generic and less matrix sensitive than that in the near-IR region of the spectrum and thus is more readily transferable from instrument to instrument. Because of these characteristics, the mid-IR region provides the information necessary to perform effective, accurate quantitative analyses on a wide variety of samples and materials.

### Experimental

An example of a suitable experimental technique for measuring the amount of oil using an FT-IR analyser is as follows.
1. Introduction and Scope
1.1 This method permits the determination of hydrocarbons on solids by solvent extraction and analysis by IR using an FT-IR analyser.
The range of the method is about 100 mg/L (100 ppm) to about 800 mg/L (800 ppm). The range of the method can be extended by diluting samples.
2. Reagents
2.1 Base oil (S.G 0.8).
2.2 Hydrochloric acid, Conc., 1.18 SG.
2.3 Tetrachloroethylene, JT Baker Ultra-Resi analysed or equivalent.
2.4 IST (solute Florisil 5 g 35 ml cartridges or equivalent.
2.5 Salt, Sodium Chloride.
3. Equipment
3.1 Infracal TOG/TPH analyzer equipped with a 10 mm path length quartz cuvette.
3.2 Glass syringe 10 and 100 μl capacity.
3.3 Volumetric flasks, Class A, 100, 50, and 10 ml capacity.
3.4 Duran Sample bottles 250 ml capacity.
3.5 Pipette, Class A, bulb 10 and 1 ml capacity.
3.6 Measuring cylinder, glass 100 and 10 ml capacity.
3.7 Glass jar minimum capacity 10 ml.
3.8 Disposable nitrile gloves.
4. Calibration
The FT-IR analyser is calibrated to read directly in concentration levels for oil on solids. The concentration factor used during the extraction process (10:1) for samples is taken into account when calibrating the instrument (only for Produced water).
4.1.1 100 mg/L standard; Using a 10 μl capacity glass syringe, add 12.5 μL (10 μl and 2.5 μl), base oil, to a 100 ml Class A, volumetric flask, containing 50±30 ml tetrachloroethylene. Dilute to the mark with tetrachloroethylene, stopper flask and mix well.
4.1.2 200 mg/L standard; Using a 100 ul capacity glass syringe, add 25 μL, base oil, to a 100 ml Class A, volumetric flask, containing 50±30 ml tetrachloroethylene. Dilute to the mark with tetrachloroethylene, stopper flask and mix well.
4.1.3 400 mg/L standard; Using a 100 μl capacity glass syringe, add 50 μL, base oil, to a 100 ml Class A, volumetric flask, containing 50±30 ml tetrachloroethylene. Dilute to the mark with tetrachloroethylene, stopper flask and mix well.
4.1.4 800 mg/L standard; Using a 100 μl capacity glass syringe, add 100 μL, base oil, to a 100 ml Class A, volumetric flask, containing 50±30 ml tetrachloroethylene. Dilute to the mark with tetrachloroethylene, stopper flask and mix well.
4.2 Switch on FT-IR analyser for 1 hour before analysis to warm up.
4.2.1 Fill the cuvette with clean solvent, tetrachloroethylene. Clean the outside of the cuvette with a soft tissue. Place the cuvette into the sample (Holder) with the frosted sides facing front and back. Ensure the cuvette is pushed down fully all the way to the stop. Press RUN. In 10-20 sec a result will be displayed. If the figure is not within±02, re-zero the instrument.
4.2.2 To re-zero instrument, place the blank sample, clean solvent, in the FT-IR analyser as above. Press and hold the ZERO button until the display reads bal. release the button. A multiplier value to 3 decimal places will be displayed when zero is established. The actual value shown is only of interest when reporting problems to the factory.
4.2.3 Press RUN. If the result is not within±02 repeat the zero process. The Infracal is now ready for calibration.
4.3.1 Press the CAL button for two seconds, until CAL appears on the display. Press the RECALL button to display the active table, either User, Edit or Off. Press RECALL repeatedly to scroll through the above list until User is displayed.
4.3.2 Momentarily press and release the CAL button. The display will read SA01.
4.3.3 Fill the cuvette with the lowest concentration standard, 4.1.1 100 mg/L equivalent, and insert into the sample holder. Press the RUN button. Run is displayed during the measurement cycle, followed by the raw absorption value. Scale the number upward by pressing the UP arrow (RUN) button or downward by pressing the DOWN arrow (RECALL) button until the concentration of the standard, in this case 100, is displayed. Momentarily press and release the CAL button to advance to the next standard. The display will read SA02. Wash out cuvette with clean solvent, tetrachloroethylene, and fill with 4.1.2 200 mg/L equivalent standard. Repeat the above procedure for the 200 mg/L equivalent standard.
4.3.4 Continue to repeat the above, 4.3.3, for the 400 and 800 mg/L equivalent standards. After the last standard has been run, press the ZERO button to exit the calibration mode. The display will read idle. The FT-IR analyser is now ready for analysis.
5. Reference Material—QC Sample
5.1 400 mg/L equivalent Quality Control Standard; Using a 10 μl capacity glass syringe, add 50 μl, base oil, to a 250 ml Duran bottle containing 50 ml of tetrachloroethylene.
6. Sampling
6.1 Samples are taken in a glass Duran bottles, 250 ml capacity.
6.2 Weigh 2 grams of solids sample into Duran bottle.
7. Extraction
7.1.1 Using a Jencons Zippet 50 ml adjustable dispenser or similar, add 50 ml tetrachloroethylene to the sample bottle.
7.1.2 Using a 10 ml measuring cylinder(or dispensor as above but smaller volume), add 0.2 ml 50% hydrochloric acid to the sample bottle. Add 4 g scoop sodium chloride, salt, to the sample.
7.1.3 Replace bottle cap and shake vigorously for 30 sec. and place in ultra sonic bath for 3 minutes±30 sec. (Ensure sample is labelled on lid as well as sides).
7.1.4 Remove from ultra sonic bath and place on a lab shaker for 30 minutes at 300 rpm. On completion, allow the sample bottle to stand for 5±1 minute to allow the solvent and solids layers to separate.
7.1.5 Gently decant solvent layer through a 5 g 35 ml Florisil cartridge and collect the solvent in a glass jar (If there is any discolouration in the extract post florisil cleanup, pass a second time through a new clean unused florisil cartridge). The sample is now ready to be run through the FT-IR analyser.
8. Analysis
8.1 Fill cuvette with clean solvent and check blank as per 4.2.1-4.2.3.
8.1.1 Run quality control sample, 8.1.1, by filling the cuvette with the extract, wipe the outside of the cuvette with a clean tissue to remove any dribbles of solvent. Place the cuvette into the sample holder with the frosted sides facing front and back. Ensure the cuvette is pushed down all the way to the stop.
8.2.2 Press the RUN button. The oil concentration will appear on the display within 20 sec. The result displayed should be 20±2, if not repeat calibration procedure.
8.2.3 Wash out cuvette with clean solvent and fill with sample extract, wipe the outside of the cuvette with a clean tissue to remove any dribbles of solvent. Place the cuvette into the sample holder with the frosted sides facing front and back. Ensure the cuvette is pushed down all the way to the stop.
7.2.4 Press the RUN button. The oil concentration in the water will appear on the display within 20 sec.
7.2.5 For sample results greater than 800 mg/L, the extract must be diluted into the range of the method with tetrachloroethylene (10:1). The result derived from the instrument reading must be multiplied up by the dilution factor to give the true concentration of oil on solids.

### Note

Cuvette must be washed out between each sample with clean solvent, to avoid contamination between samples.

Calibration must be carried out monthly or if the quality control sample result is out with specified limits or if a new operator uses the instrument.

Nitrile disposable gloves, boiler suite or lab coat and safety glasses must be worn while carrying out the procedure.

Refer to the hazard data sheets for the hydrochloric acid, tetrachloroethylene and base oil for handling, storage, usage and control measures.

The volumes of oil for calibration takes into account the specific gravity of the base oil, in this case an S.G. of 0.8. If other oil of different specific gravity is used for calibration, the specific gravity for the oil must be taken into account.

The instrument is calibrated with a concentration ratio of 10:1 taken into account. Any other ratio of solids to solvent will give false concentration values for oil in water.(only for produced waters)

This calibration range (gives the equivalent of) between 1000 ppm and 20000 ppm (in the 2 g cuttings sample) before dilution is required.

### Calculation Examples

Sample 2 grams solids in 50 ml Trichloroethylene
1. FT-IR analyzer reads 208
208 divided by 20 divided by 2=5.2 gr/L×1000=5200 mg/L or 5200 ppm
2. FT-IR analyzer reads 600

600 divided by 20 divided by 2=15 gr/L×1000=15000 mg/L or 15000 ppm

It will be clear to those of skill in the art, that the above described embodiment of the present invention is merely exemplary and that various modifications and improvements thereto may be made without departing from the scope of the present invention. For example, any suitable ultrasonic means and agitation means may be used. Moreover, any form of IR spectrometer may be used to analyse the contaminated material.

1.-31. (canceled)

32. A modular waste solid cleaning apparatus comprising:
an agitation module adapted to agitate a fluid-contaminated waste solid;
a dryer adapted to separate and remove the fluid from the fluid-contaminated waste solid, the dryer being fluidly connected to the agitation module;
a process module adapted to remove fluid from the fluid-contaminated waste solid; and
a control module adapted to control at least one parameter of each of the agitation module and the process module.

33. A modular waste solid cleaning apparatus according to claim 32, wherein the fluid-contaminated waste solid is a drilling waste including that of drill cuttings and the drill cuttings are saturated with oil and comprise up to about 20% oil by weight.

34. A modular waste solid cleaning apparatus according to claim 32, wherein the dryer is a vertical cuttings dryer and is located above the process module.

35. A modular waste solid cleaning apparatus according to claim 32, wherein the treatment module includes means to further reduce the particle size to an average particle size of less than about 1000 microns, less than about 100 microns, or most less than about 10 microns, and the reduction in particle size is performed using shearing means.

36. A modular waste solid cleaning apparatus according to claim 32, wherein the treatment module is adapted to mix the fluid-contaminated solid with a water-based solution of a surfactant and the modular waste solid cleaning apparatus include means for separating the fluid from the solid waste material which comprise a vertical cuttings dryer provided as a separate pre-treatment module and the modular waste solid cleaning apparatus comprises post process centrifuges including one post-treatment vertical cuttings dryer and one decanter centrifuge.

37. A modular waste solid cleaning apparatus according to claim 32, wherein the process module includes liquid chemical separation means which comprises one or more flocculation tanks;
the control module includes testing means for testing one or both of the waste solid and the separated fluid which controls a majority or all of the parameters in the process module and the testing means is adapted for testing the obtained solid material to ensure that the amount of fluid has been reduced to an acceptable level such as below about 1% fluid by weight; or
wherein the modular waste solid cleaning apparatus includes filtering means for filtering the separated fluid which is provided as a separate filtration module.

38. A modular waste solid cleaning apparatus according to claim 32, wherein solid material which includes an amount of fluid which has been reduced to an acceptable level is capable of being discarded overboard from an oil platform or vessel onto the seabed.

39. A method of cleaning fluid-contaminated waste solid material, said method comprising:
providing an agitation module adapted to agitate a fluid-contaminated waste solid;
providing a dryer adapted to separate and remove the fluid from the fluid-contaminated waste solid, the dryer being fluidly connected to the agitation module;
providing a process module adapted to remove fluid from the fluid-contaminated waste solid; and
providing a control module adapted to control at least one parameter of each of the agitation module and the process module.

40. A waste solid cleaning apparatus comprising:
a separating apparatus adapted to separate fluid from a fluid-contaminated waste solid; and
a collecting container for collecting the waste solid following fluid separation, the collecting container having one or more side walls, a base and at least one base tube provided at the base for releasing the collected waste solid from the collecting container,
wherein the or each side wall is substantially vertical, and wherein the base is substantially horizontal.

41. A waste solid cleaning apparatus according to claim 40, wherein there is a plurality of base tubes provided at the base;
each base tube comprises a cylindrical pipe having a substantially vertical orientation;
the collecting container comprises a number of substantially vertical surfaces as well as the substantially horizontal surface of the base which is capable of inhibiting the waste solid material from forming a bridge which can prevent other solid material from falling into the base tube;
wherein base clearing means are provided for clearing the horizontal base of the collecting container and the base clearing means comprise one or more of a sweeping device and/or vibrating means; or
the separating apparatus comprises a cuttings dryer and a vertical cuttings dryer.

42. A waste solid cleaning apparatus according to claim 40, wherein the fluid-contaminated waste solid is a drilling waste including that of drill cuttings, and base tubes are capable of releasing collected waste solid from the collecting container to further treatment apparatus or are capable of releasing the collected waste solid from the collecting container to one or more storage devices.

43. A waste solid cleaning apparatus according to claim 41, wherein the fluid-contaminated waste solid is a drilling waste including that of drill cuttings, and base tubes are capable of releasing collected waste solid from the collecting container to further treatment apparatus or are capable of releasing the collected waste solid from the collecting container to one or more storage devices.

44. A method of analyzing an amount of oil in an oil-contaminated material said method comprising the following steps:
treating the oil-contaminated material with ultrasonic means;
agitating the oil-contaminated material; and
analyzing the oil-contaminated material using IR spectroscopy.

45. A method of analyzing an amount of oil in an oil-contaminated material according to claim 44, wherein the method is capable of being used to analyze the amount of oil in an oil-contaminated waste material in an offshore environment the amount of oil in drill cuttings from an offshore rig, and other oily wastes from refinery wastes.

46. A method of analyzing an amount of oil in an oil-contaminated material according to claim 44, wherein the ultrasonic means operate in the ultrasonic range of about 15-400 kHz or about 100-200 kHz which has the effect of causing high frequency vibrations in the oil-contaminated material which aids the removal of the oil from the contaminated material; and
the contaminated material is treated with ultrasonic means for about 15 seconds, 30 seconds, 45 seconds, 1 minute, 1.5 minutes, 2 minutes, 2.5 minutes, 3 minutes, 3.5 minutes, 4 minutes, 4.5 minutes, 5 minutes, 6 minutes, 7 minutes, 8 minutes, 9 minutes or 10 minutes, or the oil-contaminated material is agitated to further promote the release of the oil from the contaminated material using a vibrator at a rate of about 10 to about 300 RPM for about 5 minutes, 10 minutes, 15 minutes, 20 minutes, 25 minutes, 30 minutes, 35 minutes, 40 minutes, 45 minutes, 50 minutes, 55 minutes and 60 minutes.

47. A method of analyzing an amount of oil in an oil-contaminated material according to claim 44, wherein an FT-IR spectrometer is used to provide precise and accurate quantitative measurement of the amount of oil in the fluid-contaminated waste solid.
